(19) United States
(12) Patent Application Publication
(10) Pub. No.: US 2007/0177531 A1
(43) Pub. Date: Aug. 2, 2007

(54) Frame processing apparatus and method in wireless LAN

(76) Inventor: Seon-Soo Rue, Suwon-si (KR)

Correspondence Address: Robert E. Bushnell, Suite 300, 1522 K Street, N.W., Washington, DC, 20005-1202, US

(21) Appl. No.: 11/653,870

(22) Filed: Jan. 17, 2007

(30) Foreign Application Priority Data
Jan. 27, 2006 (KR) 10-2006-0008949

(51) Int. Cl. H04B 7/005; H04Q 7/00

(52) U.S. Cl. 370/278; 370/329

(57) ABSTRACT

A frame processing method in a wireless local area network includes: confirming quality status according to signal level value of a frame received via a wireless medium, error status of a frame or receipt status of an acknowledgment frame in response to frame transmission; determining split size information of a transmitting frame according to the quality status; and upon generation of the transmitting frame, splitting and transmitting the transmitting frame according to size information of the transmitting frame and the split size information. The frame size is optimized when frames are transmitted between an access point (AP) and a station, thereby maximizing a service area that the AP can cover while maximizing frame transmission rate.

### CLAIM OF PRIORITY

This application makes reference to, incorporates the same herein, and claims all benefits accruing under 35 U.S.C. §119 from an application for APPARATUS AND METHOD OF PROCESSING FRAME IN WIRELESS LAN earlier filed in the Korean Intellectual Property Office on 27 Jan. 2006 and there duly assigned Serial No. 2006-8949.

### BACKGROUND OF THE INVENTION

1. Field of the Invention

The present invention relates to a frame processing method and apparatus in a wireless LAN (Local Area Network).

2. Description of the Related Art

Nowadays, wireless Local Area Networks (LANs) and their subscribers are increasing thanks to the development of network technology.

A wireless LAN supports a subscriber to wirelessly access a network by using a station such as a Personal Digital Assistant (PDA) or a notebook computer in a specific wireless service area around an Access Point (AP).

Such a wireless LAN provides a fixed capacity of Maximum Transfer Unit (MTU) that the AP and the station can transmit as a MAC (Media Access Control) Protocol Data Unit in one time through interconnection.

For example, where a frame MTU that can be transmitted in one time is 1500 byte, the AP or the station splits a 9000 byte frame into six (6) split frames to transmit. Here, in case of File Transfer Protocol (FTP), the 6 split frames are transmitted sequentially, but in case of Transmission Control Protocol (TCP), a next one of the split frames is transmitted upon receipt of an ACK (acknowledgment) frame.

A typical wireless LAN has an environment in which multiple APs are installed with overlapping service areas, and exchanges frames with a station in a service area of an AP through a selected wireless medium or channel.

However, if the distance between the AP and the station gets longer or a number of frame collisions take place owing to frequent channel interference, frames may obtain bit errors, causing frame errors to a receiving part.

Therefore, the receiving part inspects received frames to determine whether or not they have a Cyclic Redundancy Check (CRC) error, and discards a frame with a frame error, if any, and then a transmitting part retransmits the discarded frame. Such a process is repeated, further increasing congestion of wireless media, and thus frame collisions may take place more frequently.

The transmitting part repeats re-transmission of frames, increasing the quantity of frames stored in a buffer for transmission. This results in making the latency of transmission data more severe.

That is, when wireless media between the AP and the station in the wireless LAN system do not have an ideal environment, the holding time by the wireless media increase in proportion to frame size, and thus increasing the probability of bit error.

Furthermore, since a transmitting part converts again to an exchanging mode of Request To Send (RTS)/Clear To Send (CTS) frames if an ACK frame is not received from a receiving part, transmission of frames is delayed.

### SUMMARY OF THE INVENTION

The present invention has been made to solve the foregoing problems of the prior art and it is therefore an object of the present invention to provide a frame processing method and apparatus in a wireless LAN which can optimize the size of a transmitting frame according to the status of a wireless medium as well as maximize a service area where an AP can exchange frames with a station.

According to an aspect of the invention for realizing the above objects, the invention provides a wireless LAN comprising a frame processing unit adapted to check a transmission status of a wireless medium to which frames are to be transmitted, upon generation of a frame to be transmitted to the wireless media, split and transmit the frame to be transmitted according to split size information adjustable according to the transmission status.

Preferably, the frame processing unit comprises: an interface for transmitting/receiving frames via the wireless medium; a frame processor for determining the split size information corresponding to a quality status according to a signal level value acquired from a frame received via the interface, error status of the received frame or receipt status of an acknowledgment frame received in response to frame transmission; and a memory for storing the split size information according to the wireless medium determined by the frame processor.

Preferably, the frame processing unit is adapted to decrease the split size information at a predetermined ratio if the signal level value is lower than a reference level value, if a number of errors in the received frame exceeds a preset reference number, or the acknowledge frame in response to frame transmission is not received within a preset time period.

Preferably, the frame processing unit is adapted to decrease the split size information to a ratio of 50%.

Preferably, the frame processing unit is adapted to increase the split size information to a predetermined ratio if the signal level value is the reference level value or higher.

Preferably, the frame processing unit is adapted to increase the split size information to a ratio of 100% without exceeding initial split size information.

Preferably, the signal level value is one selected from a group consisting of a received signal strength indication (RSSI) value and a signal-to-noise ratio (SNR) value.

Preferably, the frame processing unit comprises: a quality confirming part for acquiring the signal level value from the received frame and counting the number of errors in the received frame and the number of transmission failures if the acknowledgment frame in response to the frame transmission is not received within the predetermined time period; and a size determining part for determining the split size information according to the signal level value, the number of errors or the number of transmission failures acquired by the quality confirming part.

Preferably, the memory is adapted to further store the split size information according to a grade with at least one signal level value classified.

Preferably, the size determining part is adapted to determine split size information corresponding to a signal level grade including the signal level value acquired by the quality confirming part.

Preferably, the quality confirming part comprises: a signal confirming part for acquiring the RSSI or SNR value from the received frame; an error confirming part for performing error-check to the received frame according to one selected from the group consisting of bit error checking, frame error checking and cyclic redundancy check (CRC) error checking, if an error takes place, discarding the received frame, and counting the number of errors; and a receipt confirming part for counting the number of transmission failures if the acknowledgment frame in response to frame transmission is not received within the predetermined time period.

According to an aspect of the invention for realizing the above objects, the invention provides an access point of a wireless LAN comprising: an interface for transmitting/receiving frames to/from at least one station via a wireless medium; a frame processor for determining split size information corresponding to quality status according to signal level value acquired from a frame received via the interface, error status of the received frame or receipt status of an acknowledgment frame received in response to frame transmission; and a memory for storing the split size information according to the wireless medium determined by the frame processor.

Preferably, if there is a frame to be transmitted to the station, the frame processor is adapted to split and transmit the transmitting frame according to size information of the transmitting frame and split size information of the station.

According to an aspect of the invention for realizing the above objects, the invention provides a station of a wireless LAN comprising: an interface for transmitting/receiving frames to/from an access point via a wireless medium; a frame processor for determining split size information of a frame to be transmitted to the access point according to a signal level value acquired from a frame received via the interface, an error status of the received frame or a receipt status of an acknowledgment frame received in response to frame transmission; and a memory for storing the split size information of the access point determined by the frame processor.

According to an aspect of the invention for realizing the above objects, the invention provides a frame processing method in a wireless LAN, comprising steps of: confirming a quality status according to a signal level value of a frame received via a wireless medium, an error status of a frame or a receipt status of an acknowledgment frame in response to frame transmission; determining split size information of a transmitting frame according to the quality status; and upon generation of the transmitting frame, splitting and transmitting the transmitting frame according to size information of the transmitting frame and the split size information.

The frame processing method of the invention may further comprise steps of: storing the split size information according to grade with at least one signal level value classified; and setting the split size information corresponding to signal level grade including the acquired signal level value.

Preferably, the frame processing method may comprise: checking an error status of the received frame according to one selected from a group consisting of bit error checking, frame error checking and cyclic redundancy check (CRC) error checking; and if an error takes place, discarding the received frame, and counting the number of errors.

Preferably, the frame processing method may comprise: if an acknowledgment frame in response to frame transmission is not received within a predetermined time period, counting the number of transmission failures.

Preferably, the step of determining split size information comprises: decreasing the split size information at a predetermined ratio if the signal level value is lower than a reference level value, if the number of errors in the received frame exceeds a preset reference number, or the acknowledge frame in response to frame transmission is not received within a preset time period.

Preferably, the step of decreasing the split size information at a predetermined ratio comprises decreasing the split size information to a ratio of 50%.

Preferably, the step of confirming quality status comprises: checking whether or not the received frame has an error; if the received frame has an error, discarding the received frame and counting the number of errors; and if the number of errors exceeds a preset reference number of errors, judging the quality status of the wireless medium for the received frame as bad quality status where split size information decreases.

Preferably, the step of confirming quality status comprises: confirming whether or not an acknowledgment frame is received within a predetermined time period in response to the frame transmitted to the wireless medium; if the acknowledgment frame is not received, retransmitting the transmitting frame and counting the number of transmission failures; and if the number of transmission failures exceeds a predetermined reference number of transmission failures, judging the quality status of the wireless medium for the transmitting frame as bad quality status where split size information decreases.

According to an aspect of the invention for realizing the above objects, the invention provides a frame processing method in an access point comprising steps of: confirming a quality status according to signal level value of a frame received via a wireless medium from at least one station, an error status of a frame or a receipt status of an acknowledgment frame in response to frame transmission; determining split size information of a frame to be transmitted to the station according to the quality status; and upon generation of the transmitting frame, splitting and transmitting the transmitting frame according to size information of the station and the split size information.

According to an aspect of the invention for realizing the above objects, the invention provides a frame processing method in a station comprising steps of: confirming a quality status according to a signal level value of a frame received via a wireless medium from an access point, an error status of a frame or a receipt status of an acknowledgment frame in response to frame transmission; determining split size information of a frame to be transmitted to the access point according to the quality status; and upon generation of the transmitting frame, splitting the transmitting frame according to size information of the station and the split size information to transmit to the access point.

### BRIEF DESCRIPTION OF THE DRAWINGS

A more complete appreciation of the present invention, and many of the attendant advantages thereof, will become readily apparent as the same becomes better understood by reference to the following detailed description when considered in conjunction with the accompanying drawings in which like reference symbols indicate the same or similar components, wherein:

FIG. 1 is a diagram illustrating network connection in a wireless LAN of the invention;

FIG. 2 is a diagram illustrating frame exchange in the wireless LAN of the invention;

FIG. 3 is a block diagram illustrating a frame processing apparatus in a wireless LAN according to a preferred embodiment of the invention;

FIG. 4 is a block diagram illustrating a quality confirming part according to the preferred embodiment of the invention;

FIG. 5 is a diagram illustrating an error check process applicable to the invention;

FIG. 6 is a flowchart illustrating a frame processing method in a wireless LAN according to a preferred embodiment of the invention;

FIG. 7 is a flowchart illustrating a frame processing method in a wireless LAN according to an alternative embodiment of the invention;

FIG. 8 is a flowchart illustrating a frame processing method in a wireless LAN according to another alternative embodiment of the invention;

FIG. 9 is a flowchart illustrating a frame transmitting method in a wireless LAN according to a preferred embodiment of the invention;

FIG. 10 is a graph illustrating a processing reliability of frames according to a packet processing method in a wireless LAN of the invention.

### DETAILED DESCRIPTION OF THE PREFERRED EMBODIMENTS

The present invention will now be described more fully hereinafter with reference to the accompanying drawings, in which preferred embodiments of a packet processing apparatus and method of the invention are shown.

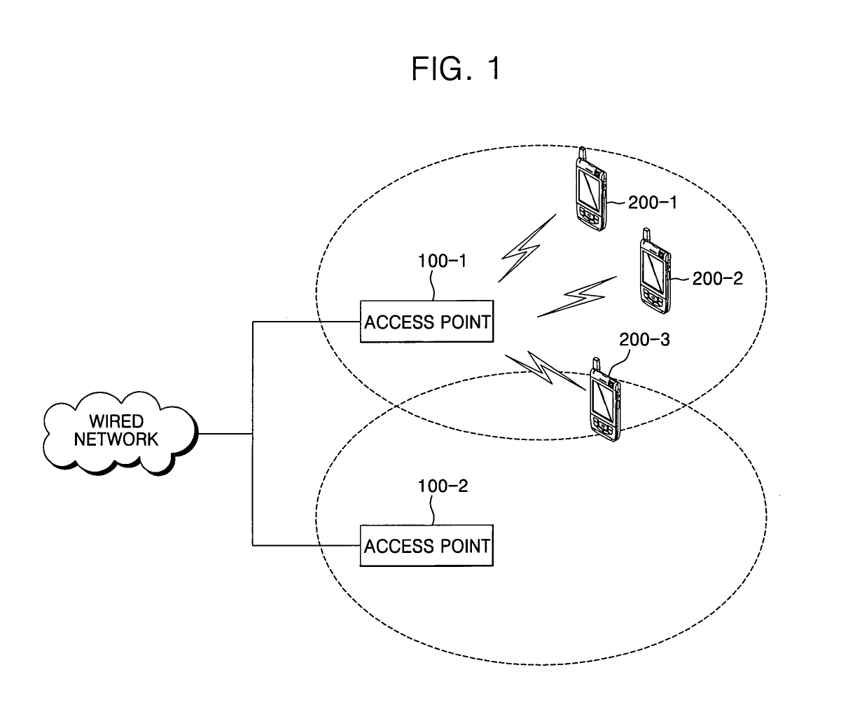

FIG. 1 is a diagram illustrating network connection in a wireless LAN of the invention.

Referring to FIG. 1, the wireless LAN includes a plurality of Access Points (APs) 100-1 and 100-2 and a plurality of wireless stations 200-1 to 200-3 which are located within a wireless service area of a corresponding one of the APs.

Each of the APs 100-1 and 100-2 (hereinafter the reference numeral “100” will be used to commonly represent 100-1 and 100-2) are connected to corresponding stations 200-1 to 200-3 (hereinafter the reference numeral “200” will be used to commonly represent 200-1 to 200-3) in its own service area via a wireless LAN (WLAN), and connected to a wired network such as a Local Area Network (LAN).

The wired network may include various network components such as an Ethernet switch, a router and a service server.

That is, the AP 100 transmits frames from each of the stations 200 to the wired network and frames from the wired network to the each station 200 such that the each station 200 connected to the AP 100 can access the wired network.

In addition, the station 200 accesses the AP via the WLAN, and transmits frames generated by user selection via a wireless medium thereto, and outputs image and audio information according to frames received therefrom, thereby providing a wireless network service to a subscriber.

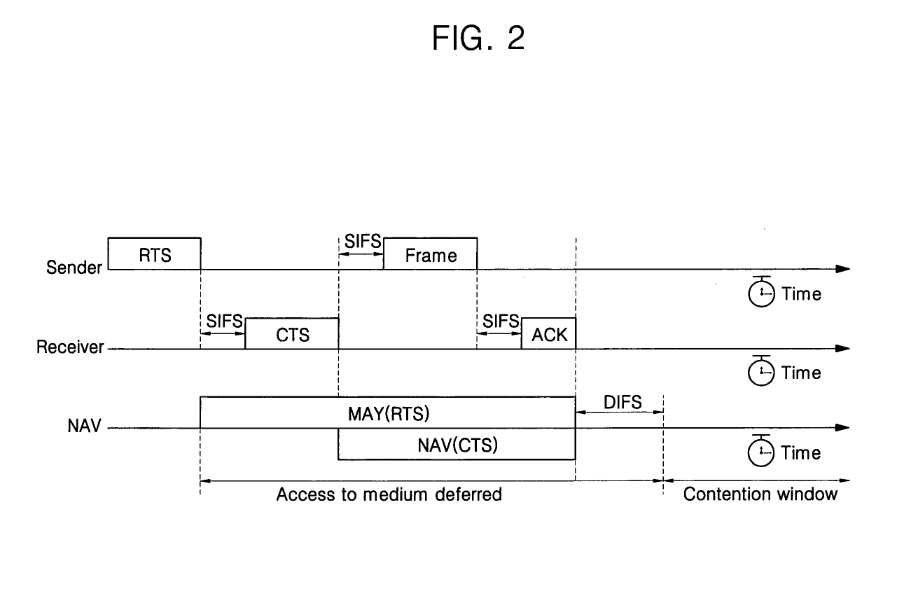

FIG. 2 is a diagram illustrating frame exchange in the wireless LAN of the invention.

As shown in FIG. 2, if there is a frame to be transmitted, a sender (e.g., the AP 100 or the station 200 shown in FIG. 1) sends an RTS (request to send) frame to a receiver (e.g., the station 200 or the AP 100 shown in FIG. 1), and generates a network allocation vector or NAV for a wireless medium MAY(RTS).

When a receiver receives the RTS frame, it sends a CTS (clear to send) frame to the sender after the duration of a Short Interframe Space (SIFS), and allocates a wireless medium via NAV(CTS).

When the CTS frame is received and a SIFS is passed, the sender transmits a data frame (FRAME) to the receiver. Upon receiving the data frame, the receiver sends an ACK frame to the sender after the duration of a SIFS, if the data frame is not erroneous.

Upon receiving the ACK frame, the sender transmits a next data frame after the duration of minimum Distribute Interframe Space (DIFS).

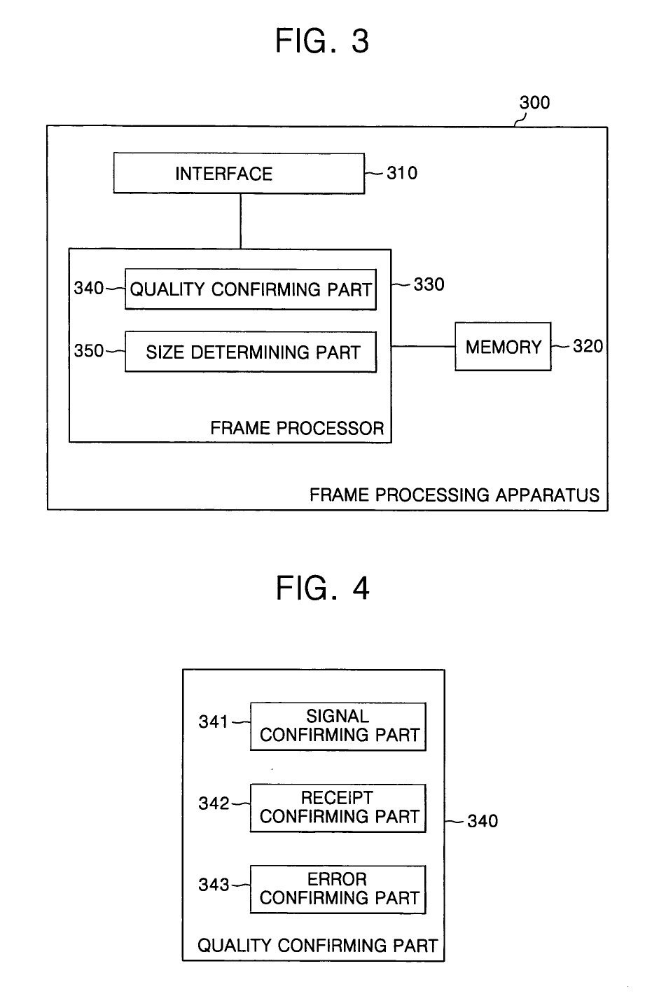

FIG. 3 is a block diagram illustrating a frame processing apparatus in a wireless LAN according to a preferred embodiment of the invention.

Referring to FIG. 3, the frame processing apparatus 300 according to this embodiment includes an interface 310, a memory 320, and a frame processor 330 which includes a size determining part 350 and a quality confirming part 340.

The frame processing apparatus 300 may be equipped in the AP 100 and/or the wireless station 200.

The interface 310 exchanges frames via a wireless medium in a wireless section. In case of AP 100, the interface 310 exchanges frames with each station 200, and in case of the station 200, the interface 310 exchanges frames with each AP 100.

The frame processor 330 identifies the quality of a corresponding wireless medium according to a frame received via the interface and stores the wireless medium in the memory 320.

In addition, the frame processor 330 determines the split size information of transmitting frames according to the quality of an identified wireless medium. That is, if a wireless medium has poor quality, the frame processor 330 decreases the split size information.

When the split size information is determined, the frame processor 330 splits a frame based on the determined split size information and transmits split frames to a corresponding wireless medium.

The memory 320 stores quality information on each wireless medium collected in the frame processor 330, and stores the split size information of frames corresponding to quality information.

Here, in case of the AP 100, the memory 320 can store quality information on each wireless medium, or store quality information and the split size information on each station 200. In case of the station 200, the memory 320 can store quality information and the split size information of the AP 100.

The quality confirming part 340 of the frame processor 330 acquires a Received Signal Strength Indication (RSSI) value or a Signal-to-Noise Ratio (SNR) value from a received frame (e.g., a data frame or beacon frame).

Here, if provided in the station 200, the quality confirming part 340 of the frame processor 330 can acquire the RSSI or SNR value from a received beacon frame.

If an ACK frame is not received at the duration of SIFS after a data frame is transmitted, the quality confirming part 340 judges that frame transmission has failed and counts the number of frame transmission failures.

In addition, the quality confirming part 340 checks bit error, frame error, and/or cyclic redundancy check (CRC) error on a received frame, and if the received frame has any errors, counts the number of errors.

The quality confirming part 340 stores acquired RSSI or SNR value and quality information including the number of transmission failures and errors to the memory 320.

The size determining part 350 determines the split size information on data frames according to quality information on each wireless medium stored in the memory 320. That is, the size determining part 350, in case of the AP 100, determines the split size information for each station 100, and in case of the station 200, determines the split size information of the AP 100.

FIG. 4 is a block diagram illustrating a quality confirming part according to the preferred embodiment of the invention.

Referring to FIG.4, the quality confirming part 340 includes a signal confirming part 341, a receipt confirming part 342 and an error confirming part 343.

The signal confirming part 341 acquires the RSSI value or the SNR value from a received frame.

For example, the signal confirming part 341 of the station 200 acquires the RSSI value or the SNR value of a beacon frame received from the AP 100 to store in the memory 320.

The signal confirming part 341 of the AP 100 acquires the RSSI value or the SNR value of a data frame received from the station 200 to store in the memory 320.

Furthermore, the size determining part 350 sets the split size information of a transmitting data frame by a value corresponding to the acquired RSSI or SNR value.

Here, if the acquired RSSI or SNR value is lower than a preset reference RSSI or SNR value, the size determining part 350 can decrease the split size information of the transmitting data frame.

If the acquired RSSI or SNR value is the same as or higher than the preset reference RSSI or reference SNR value, the size determining part 350 can increase the split size information of the data frame. However, the split size information of an increasing data frame is preferably set not to exceed initial size information.

Here, the size determining part 350 can increase and decrease the split size information of the data frame at a ratio that is a multiplication of 2. That is, the size determining part 350 can halve the split size information of the data frame when decreasing it but double the split size information when increasing it.

At the duration of SIFS after transmission of the data frame, the receipt confirming part 342 confirms whether or not an ACK frame is received, and if the ACK frame is not received, retransmits the data frame and increases a count value (number) for each transmission failure.

If the number of transmission failures exceeds a preset number of errors/failures, the size determining part 350 decreases the split size information of frames.

If an ACK frame for a data frame which the size determining part 350 split by decreasing split size information is not received, the receipt confirming part 342 retransmits the data frame and counts the number of transmission failures.

Then, with the split size information decreased, if the number of transmission failures again exceeds the preset number of errors/failures, the size determining part decreases the split size information again.

The error confirming part 343 confirms bit error, frame error or CRC error of a received data frame or beacon frame, and counts the number of errors.

That is, if a received data frame has an error, the error confirming part 343 discards the received data frame, and counts the number of errors.

If the number of errors exceeds a preset number of errors, the size determining part 350 decreases split size information of transmitting data frames.

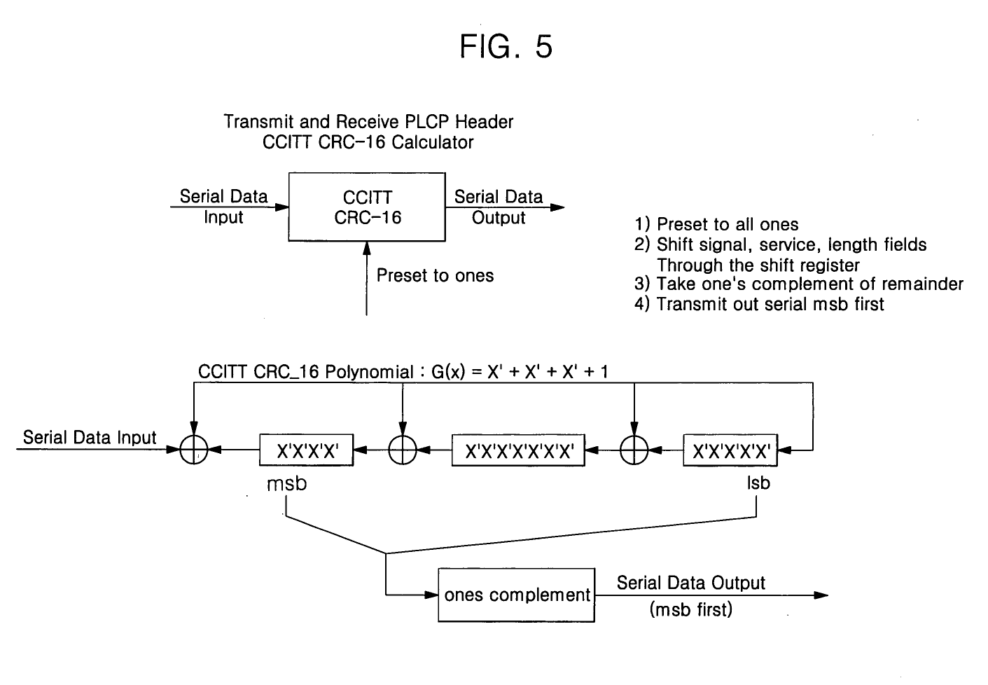

FIG. 5 is a diagram illustrating an error check process applicable to the invention.

FIG. 5 shows a CRC error checking process, in which modular 2 operation is performed on a data to be transmitted in a preset pattern (Preset to one) to CRC-16, and 16 bit value operated as remainder is attached to a transmitting data frame.

Upon receiving the data frame, a receiver performs modular operation using a preset pattern, compares a remainder bit value with the remainder bit value attached to the data frame, and if not equal, judges that an error has occurred. Such CRC is used in a frame unit, and thus also called Frame Check Sequence (FCS).

When a data frame is generated, the frame processor 330 confirms quality information of a wireless medium by which the data frame will be transmitted, confirms split size information corresponding to this quality information, if size information of the generated data frame is the same as or larger than split size information, splits the generated data frame according to split size information to send.

That is, the frame processor 330 stores, in the memory 320, split size information according to quality information on each wireless medium. Split size information of frames for each station 200 is stored in case of the AP 100, and split size information of frames to be transmitted to the AP 100 is stored in case of the station 200.

The memory 320 can store split size information of frames according to the grade of respective RSSI or SNR values, as in Table 1 below:

TABLE 1

| RSSI grade (or SNR grade) | Split size information (byte) |
|---|---|
| 1st grade | 1500 |
| 2nd grade | 750 |
| 3rd grade | 375 |

As seen in Table 1 above, size information of frames can be set according to the grade of respective RSSI or SNR values.

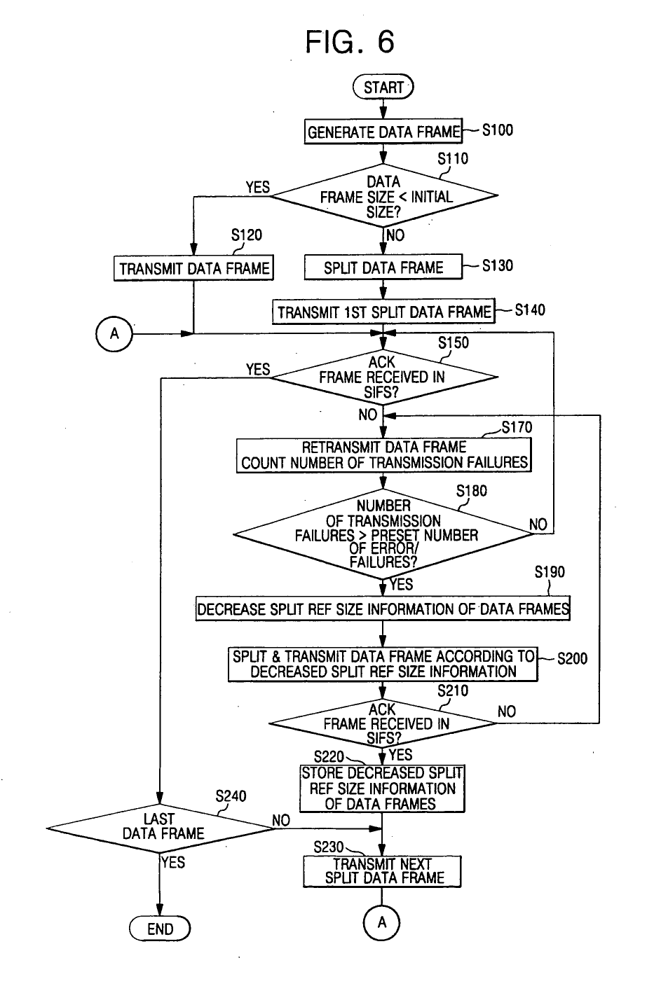

FIG. 6 is a flowchart illustrating a frame processing method in a wireless LAN according to a preferred embodiment of the invention.

Referring to FIG. 6, description will be given of a situation where the AP 100 is a transmitter and the station 200 is a receiver.

A data frame is generated in S100, and the frame processing apparatus 300 of the AP 100 confirms whether or not size information of the data frame is the same as or larger than initial size information of the data frame in S110.

The AP 100 transmits an RTS frame to the station 200, receives a CTS frame from the station 200, and if size information of the data frame is smaller than initial size information, transmits the data frame to the station 200 in S120.

If the data frame is the same as or larger than initial size information, the AP 100 splits the data frame according to initial size information in S130.

In S140, the AP 100 transmits a first one of split data frames to the station 200.

The AP 100 confirms whether or not an ACK frame is received within the duration of SIFS in S150, and if the ACK frame is received within the duration of SIFS, checks at S240 whether a last data frame has been transmitted. If not, then the AP100 transmits a next split data frame in S230. If yes, then the process ends.

However, if the ACK frame is not received at S150, the AP 100 retransmits the first split data frame, and increases a count value to count the number of transmission failures in S170.

If the number of transmission failures exceeds preset number of errors/failures in S180, the AP 100 decreases split size information of the data frame and stores decreased split size information as split size information of the station 200 in S190.

For example, where initial size information is a 1500 byte frame for the frame generated in step S100, the AP 100 decreases split size information of the data frame according to a preset ratio (e.g., 1/2 or 50%).

In S200, the AP 100 splits the generated data frame (see S100) into 750 byte frames according to the decreased split size information and transmits a corresponding new first split data frame to the station 200.

The AP 100 confirms whether or not an ACK frame is received within the duration of SIFS in S210, and if the ACK frame is received within the duration of SIFS, stores this split size information as split reference size information of the station 200 in S220.

In S230, the AP 100 transmits a next split data frame to the station 200.

However, if the ACK frame is not received within the duration of SIFS in S210, the process returns to S170 and AP 100 retransmits the first split data frame and counts the number of transmission failures.

If the number of transmission failures exceeds the preset number of errors/failures in S180, the AP 100 decreases split size information of the data frame again in S190.

Then in S200, the AP 100 splits the data frame again according to decreased split size information and transmits split data frames to the station 200.

In the meantime, in case that the station 200 is a transmitter and the AP 100 is a receiver, a similar process is carried out. That is, the station 200 transmits a data frame, and based on whether or not an ACK frame is received, sets split size information of a data frame about the AP 100.

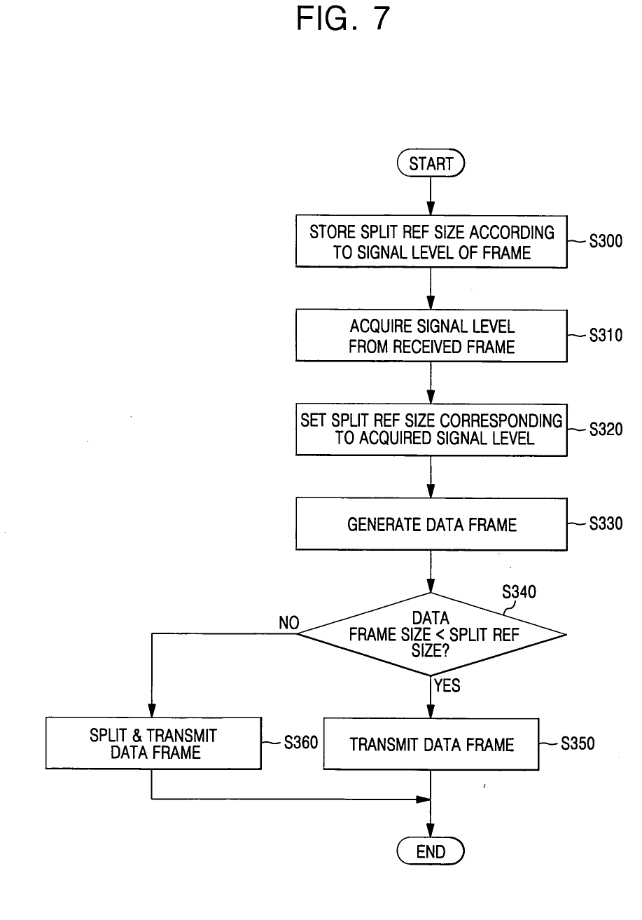

FIG. 7 is a flowchart illustrating a frame processing method in a wireless LAN according to an alternative embodiment of the invention.

Referring to FIG. 7, upon receiving a frame from the AP, the frame processing apparatus 300 of the station 200 stores reference split size information of a frame according to RSSI values or an SNR values in the form of a table in S300.

In S310, the station 200 acquires the RSSI or SNR value from a beacon frame received from the AP 100.

In S320, the station 200 sets split size information corresponding to the acquired RSSI or SNR value as split size information of the data frame to be transmitted to the AP 100.

Then, the station 200 generates a data frame in S330, and confirms whether or not size information of the generated data frame is the same as or larger than the reference split size information in S340.

Then, the station 200 transmits an RTS frame to the AP 100, and receives a CTS frame from the AP 100. In case that frame size information of the generated data frame is smaller than split size information, the station 200 transmits the data frame to the AP in S350. On the other hand, in case that frame size information of the generated data frame is the same as or larger than split size information, the station 200 splits the data frame and then transmits a first one of split data frames to the station 200 in S360.

If the RSSI or SNR value of a frame received from the AP 100 is the same as or larger than a reference RSSI or SNR value, the station 200 can increase split size information of the data frame.

In the meantime, the AP 100 can set split size information corresponding to the RSSI or SNR value of the data frame received from the station 200 as split size information of a data frame to be transmitted to the station 200.

Furthermore, if the RSSI or SNR value is smaller than a preset reference RSSI or SNR value, the AP 100 and the station 200 can decrease split size information of a data frame.

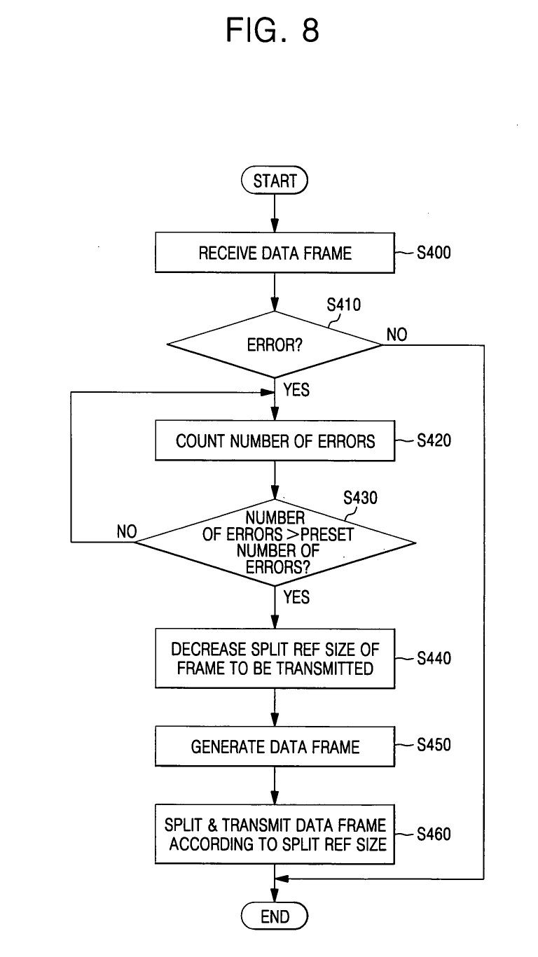

FIG. 8 is a flowchart illustrating a frame processing method in a wireless LAN according to another alternative embodiment of the invention.

Referring to FIG. 8, when a data frame is generated, the frame processing apparatus 300 of the AP 100 confirms whether or not size information of the generated data frame is the same as or larger than initial size information.

Then, the AP 100 transmits an RTS frame to the station 200, and upon receiving a CTS frame from the station 200, transmits the data frame to the station 200 if size information of the data frame is smaller than initial size information.

If size information of the data frame is the same as or larger than initial size information, the AP splits the data frame according to initial size information, and transmits a first one of split data frames to the station 200.

Station 200 receives the transmitted data frame (the original data frame or the split data frame) in S400.

Station 200 checks whether or not the split data frame has an error in S410.

Here, the error checking on the data frame may be performed by various schemes such as bit error checking, frame error checking and CRC error checking.

If the received data frame has an error, the station 200 discards the received data frame, and counts the number of data frame errors in S420. If the number of data frame errors exceeds preset number of errors S430, the station 200 decreases split size information of the data frame in S440.

That is, the station 200 decreases split size information of the data frame to be transmitted to the AP 100.

Then, when a data frame to be transmitted to the AP 100 is generated in S450, the station 200 splits the data frame according to split size information and then transmits split data frames to the AP 100 in S460.

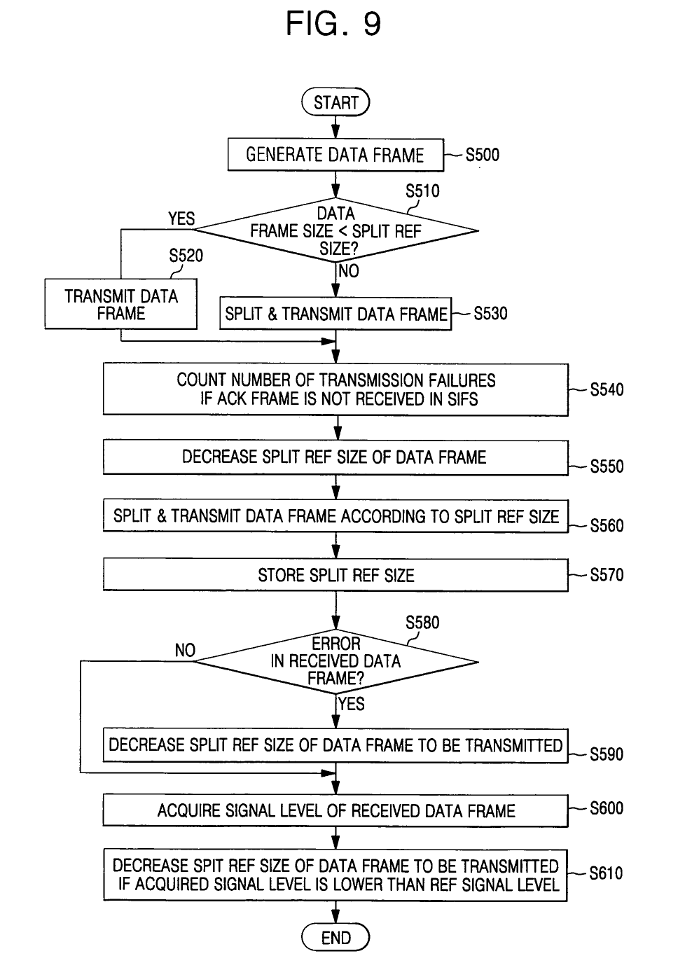

FIG. 9 is a flowchart illustrating a frame transmitting method in a wireless LAN according to a preferred embodiment of the invention.

Referring to FIG. 9, when a data frame is generated in S500, the frame processing apparatus 300 of the AP 100 or the station 200 confirms whether or not split size information is set to a wireless medium to which the data frame will be transmitted.

For example, the frame processing apparatus 300 of the AP confirms whether or not split size information is set to a wireless medium to which the data frame will be transmitted, and if split size information is not set, compares size information of the data frame with initial size information, or if split size information is set, compares size information of the data frame with split size information in S510.

The frame processing apparatus 300 transmits the data frame to the station 200 as is in S520, if size information of the data frame is smaller than initial size information, or splits the data frame according to initial size information and transmits split data frames to the station 200 in S530, if size information of the data frame is the same as or larger than initial size information.

In case that split size information is set, the frame processing apparatus 300 transmits the data frame to the station 200 as is in S520, if size information of the data frame is smaller than split size information. Otherwise, the frame processing apparatus 300 splits the data frame according to split size information and transmits split data frames to the station 200 in S530.

That is, if size information of the data frame is smaller than split size information or initial size information, the frame processing apparatus 300 transmits the data frame to the station 200 in S520.

If size information of the data frame is the same as or larger than split size information or initial size information, the frame processing apparatus 300 splits the data frame to transmit to the station 200 in S530.

Here, the frame processing apparatus 300 of the AP 100 transmits an RTS frame to the station, and upon receiving a CTS frame, transmits the data frame.

The frame processing apparatus 300 of the AP 100 confirms whether or not an ACK frame is received during the duration of SIFS, and if the ACK frame is received, transmits a next data frame.

If the ACK frame is not received, the frame processing apparatus 300 of the AP 100 retransmits the first data frame, and counts the number of transmission failures in S540.

If the number of transmission failures exceeds preset number of errors (e.g., 7 errors), the frame processing apparatus 300 of the AP 100 decreases split size information of the data frame in S550.

Here, the frame processing apparatus 300 of the AP 100 decreases split size information of the data frame according to a preset magnification (e.g., 1/2 or 50%).

The frame processing apparatus 300 of the AP 100 splits the generated data frame according to decreased split size information, and transmits a first one of split data frames to the station 200 in S560.

If an ACK frame is received in the duration of SIFS after the transmission of the first split data frame according to split size information, the AP 100 stores this split size information of the station 200 in S570.

Then, the AP 100 transmits a next split data frame according to split size information to the station 200.

In S580, the frame processing apparatus 300 of the station 200 checks whether or not the data frame received from the AP 100 has an error.

Here, the error checking on the data frame may be performed by various schemes such as bit error checking, frame error checking and CRC error checking.

If the received data frame has an error, the frame processing apparatus 300 of the station 200 discards the received data frame, and decreases split size information of a transmitting data frame to be transmitted to the AP 100 in S590.

Here, the frame processing apparatus 300 of the station 200 counts the number of errors in the received data frame, and if the counted number exceeds a preset number of errors, can decrease the reference split size information of the transmitting data frame. Accordingly, when a data frame to be transmitted to the AP 100 is generated, the frame processing apparatus 300 splits the data frame according to split size information before transmission.

Following step S580 when the received data frame has no error or step S590, the frame processing apparatus 300 of the station 200 acquires the RSSI or SNR value of the data frame received from the AP 100 in S600. Here, the frame processing apparatus 300 of the station 200 can acquire RSSI or SNR value from a data frame or beacon frame received from the AP 100.

If the RSSI or SNR value is lower than a preset reference RSSI or SNR value, the frame processing apparatus 300 of the station 200 decreases the reference split size information of the data frame to be transmitted to the AP 100 in S610.

Here, if reference split size information corresponding to RSSI values or SNR values of a data frame are stored in a table, the frame processing apparatus 300 of the station 200 sets split size information according to an acquired RSSI or SNR value as compared to the RSSI values or SNR values stored in the table.

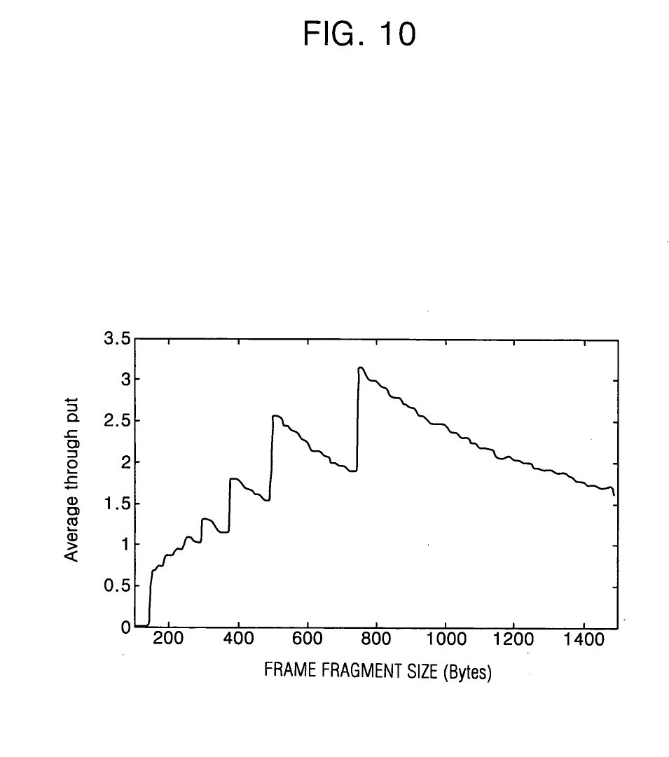

FIG. 10 is a graph illustrating a processing reliability of frames according to a packet processing method in a wireless LAN system of the invention.

In the graph shown in FIG. 10, the horizontal axis indicates size information of a frame, and the vertical axis indicates throughput. FIG. 10 shows variation in processing rate when frame size information is changed in an environment where a station is located in the outermost edge of a service area of an AP or a large number of frame collisions take plate owing to frequent channel interference.

As shown in FIG. 10, it can be observed that a processing rate rises when the frame processing apparatus 300 transmits a frame at size information of about 750 bytes that is half of the initial size information of 1500 byte, and particularly, rises sharply at a point where frame size information is halved.

Therefore, the frame processing apparatus 300 preferably increases or decreases split size information of a frame by a multiplication of 1/2 or 50%.

Although the foregoing detailed description of the invention has been made with reference to a wireless LAN where size information of a transmitting frame is properly changed according to RSSI or SNR values of the frame, the number of errors or the receipt of an ACK frame, this may be equivalently applied to another wireless LAN where size information of a transmitting frame is suitably changed according to other environments.

Furthermore, while the detailed description of the invention has been made with reference to a wireless LAN that exchanges frames according to the same IEEE 802.11 standards, this may be equivalently applied to a wireless LAN that supports a ‘protection mode’ where IEEE 802.11g and IEEE 802.11b standards are combined or mixed.

As described hereinbefore, a wireless LAN can optimize frame size when transmitting frames between an AP and a station, thereby maximizing a service area that the AP can cover while maximizing frame transmission rate.

While the present invention has been shown and described in connection with the preferred embodiments, it will be apparent to those skilled in the art that modifications and variations can be made without departing from the spirit and scope of the invention as defined by the appended claims.

What is claimed is:

1. A wireless local area network comprising:
a frame processing unit adapted to check a transmission status of a wireless medium to which frames are to be transmitted, upon generation of a frame to be transmitted to the wireless medium, split and transmit the frame to be transmitted according to split size information adjustable according to the transmission status.

2. The wireless local area network according to claim 1, wherein the frame processing unit comprises:
an interface for transmitting/receiving frames via the wireless medium;
a frame processor for determining the split size information in response to a quality status according to a signal level value acquired from a frame received via the interface, error status of the received frame or receipt status of an acknowledgment frame received in response to frame transmission; and
a memory for storing the split size information according to the wireless medium determined by the frame processor.

3. The wireless local area network according to claim 2, wherein the frame processor is adapted to decrease the split size information at a predetermined ratio if the signal level value is lower than a reference level value, if the number of errors in the received frame exceeds a preset reference number, or if the acknowledge frame in response to frame transmission is not received within a preset time period.

4. The wireless local area network according to claim 3, wherein the frame processor is adapted to decrease the split size information to a ratio of 50%.

5. The wireless local area network according to claim 3, wherein the frame processor is adapted to increase the split size information to a predetermined ratio if the signal level value is the reference level value or higher.

6. The wireless local area network according to claim 5, wherein the frame processor is adapted to increase the split size information to a ratio of 100% without exceeding initial split size information.

7. The wireless local area network according to claim 3, wherein the signal level value is one selected from a group consisting of a received signal strength indication (RSSI) value and a signal-to-noise ratio (SNR) value.

8. The wireless local area network according to claim 2, wherein the frame processor comprises:
a quality confirming part for acquiring the signal level value from the received frame and counting the number of errors in the received frame and the number of transmission failures if the acknowledgment frame in response to the frame transmission is not received within the predetermined time period; and
a size determining part for determining the split size information according to the signal level value, the number of errors or the number of transmission failures acquired by the quality confirming part.

9. The wireless local area network according to claim 2, wherein the memory is adapted to further store the split size information according to a grade at which at least one signal level value is classified.

10. The wireless local area network according to claim 8, wherein the size determining part is adapted to determine split size information corresponding to a signal level grade including the signal level value acquired by the quality confirming part.

11. The wireless local area network according to claim 8, wherein the quality confirming part comprises:
a signal confirming part for acquiring a received signal strength indication (RSSI) value or a signal-to-noise ratio (SNR) value from the received frame;
an error confirming part for performing error-check to the received frame according to one selected from the group consisting of bit error checking, frame error checking and cyclic redundancy check (CRC) error checking, if an error takes place, discarding the received frame, and counting the number of errors; and
a receipt confirming part for counting the number of transmission failures if the acknowledgment frame in response to frame transmission is not received within the predetermined time period.

12. An access point of a wireless local area network comprising:
an interface for transmitting/receiving frames to/from at least one station via a wireless medium;
a frame processor for determining split size information corresponding to a quality status according to a signal level value acquired from a frame received via the interface, an error status of the received frame or a receipt status of an acknowledgment frame received in response to frame transmission; and
a memory for storing the split size information according to the wireless medium determined by the frame processor.

13. The access point according to claim 12, wherein the frame processor is adapted to, if there is a frame to be transmitted to the station, split and transmit the transmitting frame according to size information of the transmitting frame and split size information of the station.

14. A station of a wireless local area network comprising:
an interface for transmitting/receiving frames to/from an access point via a wireless medium;
a frame processor for determining split size information of a frame to be transmitted to the access point according to a signal level value acquired from a frame received via the interface, an error status of the received frame or a receipt status of an acknowledgment frame received in response to frame transmission; and
a memory for storing the split size information of the access point determined by the frame processor.

15. A frame processing method in a wireless local area network, comprising steps of:
confirming a quality status according to a signal level value of a frame received via a wireless medium, an error status of a frame or a receipt status of an acknowledgment frame in response to frame transmission;
determining split size information of a transmitting frame according to the quality status; and
upon generation of a frame to be transmitted, splitting and transmitting the frame according to size information of the frame and the split size information.

16. The frame processing method according to claim 15, further comprising steps of:
storing the split size information according to a grade at which at least one signal level value is classified; and
setting the split size information corresponding to the grade corresponding to the acquired signal level value.

17. The frame processing method according to claim 15, wherein the step of confirming quality status comprises:
checking whether or not the received frame has an error;
if the received frame has an error, discarding the received frame and counting the number of errors; and
if the number of errors exceeds preset reference number of errors, judging the quality status of the wireless medium for the received frame as bad quality status where split size information decreases.

18. The frame processing method according to claim 15, wherein the step of confirming quality status comprising:
confirming whether or not an acknowledgment frame is received within a predetermined time period in response to the frame transmitted to the wireless medium;
if the acknowledgment frame is not received, retransmitting the transmitting frame and counting the number of transmission failures; and
if the number of transmission failures exceeds predetermined reference number of transmission failures, judging the quality status of the wireless medium for the transmitting frame as bad quality status where split size information decreases.

19. A frame processing method in an access point comprising steps of:
confirming quality status according to signal level value of a frame received via a wireless medium from at least one station, error status of a frame or receipt status of an acknowledgment frame in response to frame transmission;
determining split size information of a frame to be transmitted to the station according to the quality status; and
upon generation of the transmitting frame, splitting and transmitting the transmitting frame according to size information of the station and the split size information.

20. A frame processing method in a station comprising steps of:
confirming quality status according to signal level value of a frame received via a wireless medium from an access point, error status of a frame or receipt status of an acknowledgment frame in response to frame transmission;
determining split size information of a frame to be transmitted to the access point according to the quality status; and
upon generation of the transmitting frame, splitting the transmitting frame according to size information of the station and the split size information to transmit to the access point.
